(19) United States
(12) Patent Application Publication
(10) Pub. No.: US 2023/0018093 A1
(43) Pub. Date: Jan. 19, 2023

(54) METHODS FOR PHYSICAL DOWNLINK CONTROL CHANNEL (PDCCH) MONITORING ADAPTATION IN 5G NEW RADIO (NR)

(71) Applicant: MediaTek INC., Hsin-Chu (TW)

(72) Inventors: Yi-Ju Liao, Hsin-Chu (TW); Wei-De Wu, Hsin-Chu (TW); Lung-Sheng Tsai, Hsin-Chu (TW); Yi-Chia Lo, Hsin-Chu (TW)

(21) Appl. No.: 17/946,513

(22) Filed: Sep. 16, 2022

Related U.S. Application Data
(63) Continuation of application No. PCT/CN2021/081258, filed on Mar. 17, 2021.
(60) Provisional application No. 62/990,490, filed on Mar. 17, 2020.
(60) Provisional application No. 62/990,493, filed on Mar. 17, 2020.

(51) Int. Cl. H04W 76/28; H04W 72/12

(52) U.S. Cl. CPC H04W 76/28; H04W 72/1289

(57) ABSTRACT

A method for Downlink Control Information (DCI)-based Physical Downlink Control Channel (PDCCH) monitoring adaptation is proposed. A User Equipment (UE) performs a Discontinuous Reception (DRX) operation. The UE detects a UE-specific DCI format during the DRX operation, wherein the UE-specific DCI format includes a bit field that indicates an adaptation on PDCCH monitoring. The UE adjusts a PDCCH monitoring periodicity in a DRX active time of the DRX operation according to the bit field.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/081258, with an international filing date of Feb. 5, 2021, which in turn claims priority from U.S. Provisional Application No. 62/990,490, entitled “Efficient Adaptation Triggering for PDCCH monitoring reduction in Connected-mode”, filed on Mar. 17, 2020, and U.S. Provisional Application No. 62/990,493, entitled “Efficient Adaptation Triggering for UE Power Saving in M-DCI based M-TRP with Non-ideal Backhaul”, filed on Mar. 17, 2020. This application is a continuation of International Application No. PCT/CN2021/081258, which claims priority from U.S. provisional applications 62/990,490 and 62/990,493. International Application No. PCT/CN2021/081258 is pending as of the filing date of this application, and the United States is a designated state in International Application No. PCT/CN2021/081258. The disclosure of each of the foregoing documents is incorporated herein by reference. the subject matter of which is incorporated herein by reference.

### TECHNICAL FIELD

The disclosed embodiments relate generally to wireless communication, and, more particularly, to methods for Physical Downlink Control Channel (PDCCH) monitoring adaptation in 5G New Radio (NR).

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an Evolved Universal Terrestrial Radio Access Network (E-UTRAN) includes a plurality of evolved Node-Bs (eNodeBs or eNBs) communicating with a plurality of mobile stations, referred to as User Equipments (UEs). The 3^{rd} Generation Partner Project (3GPP) network normally includes a hybrid of 2G/3G/4G systems. With the optimization of the network design, many improvements have developed over the evolution of various standards. The Next Generation Mobile Network (NGMN) board, has decided to focus the future NGMN activities on defining the end-to-end requirements for 5G New Radio (NR) systems.

Some wireless communication technologies, including 4G/LTE and 5G/NR, employ a technique called Discontinuous Reception (DRX) to conserve system resources. In a DRX operation, a UE generally performs wireless reception in a DRX ON duration, and switches to power saving mode in a DRX OFF duration since the network will not be transmitting any data to the UE in the OFF duration. Specifically, the UE needs to monitor the Physical Downlink Control Channel (PDCCH) in the DRX ON duration, to see if the network transmits any data to the UE. With the DRX operation, the UE is allowed to go to sleep in the DRX OFF duration of each DRX cycle, which reduces the UE's power consumption.

However, it is observed in the 5G/NR Daily of Use (DoU) analysis that, most of the time, the PDCCH monitoring performed without further data. That is, the UE always monitors the PDCCH in the DRX ON duration, but the network may not have any data to transmit to the UE. Such PDCCH monitoring without further data may consume a large portion of UE's battery power, especially for the cases where data is configured with short inter-packet arrival time.

A solution is sought.

### SUMMARY

A method for Downlink Control Information (DCI)-based Physical Downlink Control Channel (PDCCH) monitoring adaptation is proposed. A User Equipment (UE) performs a Discontinuous Reception (DRX) operation. The UE detects a UE-specific DCI format during the DRX operation, wherein the UE-specific DCI format comprises a bit field that indicates an adaptation on PDCCH monitoring. The UE adjusts a PDCCH monitoring periodicity in a DRX active time of the DRX operation according to the bit field.

In some examples, the UE-specific DCI format is a scheduling DCI using DCI format 0_1, 1_1, 0_2, or 1_2. The adjusting of the PDCCH monitoring periodicity may be performed for all types of SSS, or for type-3 common SSS and UE-specific SSS, or for UE specific SSS only. In one embodiment, the UE may switch from a first SSS to a second SSS (e.g., a dormant SSS) in response to the bit field indicates SSS switching, wherein the second SSS, compared to the first SSS, is configured with no PDCCH monitoring or PDCCH monitoring with longer period or smaller number of PDCCH candidates. For instance, the UE may stop monitoring DCI scrambled by any one of a Cell-Radio Network Temporary Identifier (C-RNTI), a Configured Scheduling-RNTI (CS-RNTI), and a Modulation Coding Scheme-Cell-RNTI (MCS-C-RNTI) in response to switching to a dormant SSS. In another embodiment, the bit field may indicate a ratio of PDCCH monitoring periodicity reduction. In yet another embodiment, the UE may disable a configured SSS in response to the bit field indicates SSS disabling, and not perform PDCCH monitoring in response to disabling the configured SSS. In still another embodiment, for the scenario of M-DCI based M-TRP transmission, the bit field may indicate adaptation on PDCCH monitoring for a first SSS having the same CORESET pool index value as a second SSS where the UE-specific DCI format is detected. In still another embodiment, the UE may receive a Radio Resource Control (RRC) message comprising a timer value, and start the timer in response to the UE-specific DCI format, wherein the adjusting of the PDCCH monitoring periodicity is performed when the time expires.

A method for timer-based PDCCH monitoring adaptation is proposed. A UE receives a first timer value from a wireless network, wherein the first timer value is less than a BWP inactivity timer value. The UE starts the BWP inactivity timer at a start of a DRX active time. The UE applies a PDCCH monitoring periodicity in the DRX active time before the BWP inactivity timer reaches the first timer value. The UE adjusts the PDCCH monitoring periodicity in the DRX active time in response to the BWP inactivity timer reaching the first timer value.

In some examples, the first timer value is received in an RRC message. In one embodiment, the UE may perform PDCCH monitoring in a first SSS using the PDCCH monitoring periodicity from the start of the DRX active time, switches from the first SSS to a second SSS by the UE in response to the BWP inactivity timer reaching the first timer value, and applies the adjusted PDCCH monitoring periodicity in the second SSS by the UE before the BWP inactivity timer expires. In another embodiment, the UE may perform PDCCH monitoring in an SSS using the PDCCH monitoring periodicity before the BWP inactivity timer reaches the first timer value, and applies the adjusted PDCCH monitoring periodicity in the SSS in response to the BWP inactivity timer reaching the first timer value. In yet another embodiment, the UE may apply the adjusted PDCCH monitoring periodicity in response to the BWP inactivity timer reaching the first timer value, and switch back to the PDCCH monitoring periodicity in response to the BWP inactivity timer being reset. In still another embodiment, for the scenario of M-DCI based M-TRP transmission, the first timer value and an SSS corresponding to the adjusted PDCCH monitoring periodicity are associated with the same CORESET pool index value.

A method for UE autonomous PDCCH monitoring adaptation is proposed. A UE performs a DRX operation with a wireless network. The UE receives data scheduling information from the wireless network during the DRX operation, wherein the data scheduling information indicates data scheduling for a last TB. The UE adjusts a PDCCH monitoring periodicity in a DRX active time of the DRX operation in response to the data scheduling information.

In some examples, the data scheduling information is included in a bit field of a UE-specific DCI format which is a scheduling DCI using DCI format 0_1, 1_1, 0_2, or 1_2. In one embodiment, the UE may perform PDCCH monitoring in a first SSS using the PDCCH monitoring periodicity from the start of the DRX active time, switch from the first SSS to a second SSS in response to the bit field, and apply the adjusted PDCCH monitoring periodicity in the second SSS. In particular, for the scenario of M-DCI based M-TRP transmission, the first SSS and the second SSS are associated with the same CORESET pool index value. In another embodiment, the UE may receive an RRC message comprising a timer value, and start the timer in response the UE-specific DCI format, wherein the adjusting of the PDCCH monitoring periodicity is performed when the time expires. In yet another embodiment, the adjusting of the PDCCH monitoring periodicity is performed after the UE transmits an Acknowledgement (ACK) for the corresponding scheduling data

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G New Radio (NR) network 100 supporting Physical Downlink Control Channel (PDCCH) monitoring adaptation in accordance with aspects of the current invention.

FIG. 2 illustrates an exemplary DRX operation in accordance with aspects of the current invention.

FIG. 3 illustrates simplified block diagrams of wireless devices, e.g., a UE 301 and a gNB/TRP 311 in accordance with embodiments of the current invention.

FIGS. 4A and 4B illustrate an embodiment of the DCI-based PDCCH monitoring adaptation in accordance with one novel aspect.

FIG. 5 illustrate an embodiment of the DCI-based PDCCH monitoring adaptation for the scenario of M-DCI based M-TRP transmission in accordance with one novel aspect.

FIGS. 6A and 6B illustrate another embodiment of the DCI-based PDCCH monitoring adaptation in accordance with one novel aspect.

FIGS. 7A and 7B illustrate another embodiment of the DCI-based PDCCH monitoring adaptation in accordance with one novel aspect.

FIGS. 8A and 8B illustrate another embodiment of the DCI-based PDCCH monitoring adaptation in accordance with one novel aspect.

FIG. 9 illustrates an example of DCI indication using existing bit field “Minimum applicable scheduling offset indicator” in accordance with one novel aspect.

FIG. 10 illustrates an embodiment of the timer-based PDCCH monitoring adaptation in accordance with one novel aspect.

FIG. 11 illustrates an embodiment of the UE autonomous PDCCH monitoring adaptation in accordance with one novel aspect.

FIG. 12 illustrates a flow chart of a method for DCI-based PDCCH monitoring adaptation in accordance with one novel aspect.

FIG. 13 illustrates a flow chart of a method for timer-based PDCCH monitoring adaptation in accordance with one novel aspect.

FIG. 14 illustrates a flow chart of a method for UE-autonomous PDCCH monitoring adaptation in accordance with one novel aspect.

### DETAILED DESCRIPTION

Reference will now be made in detail to some embodiments of the invention, examples of which are illustrated in the accompanying drawings.

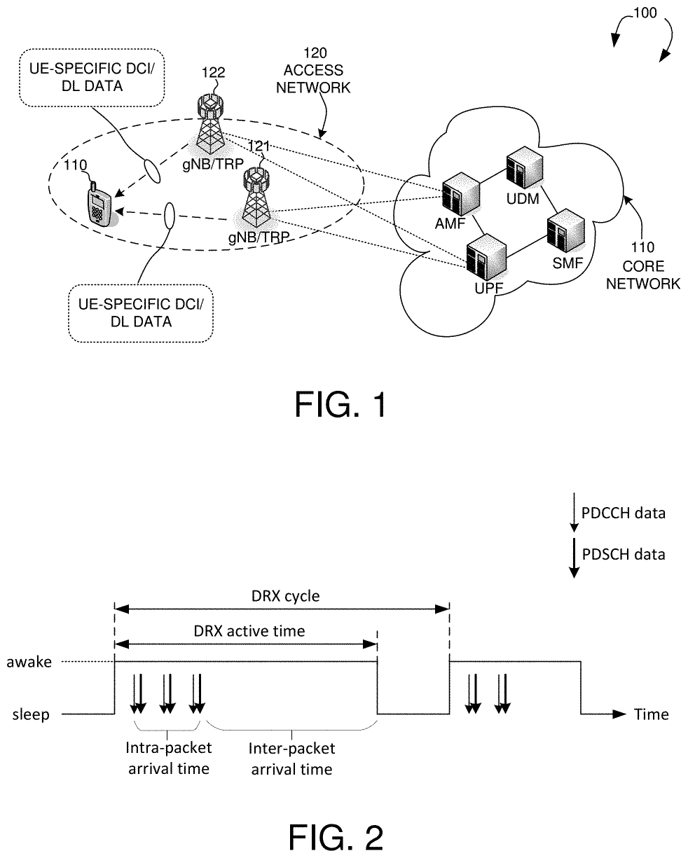

FIG. 1 illustrates an exemplary 5G New Radio (NR) network 100 supporting Physical Downlink Control Channel (PDCCH) monitoring adaptation in accordance with aspects of the current invention. The 5G NR network 100 comprises a User Equipment (UE) 110 communicatively connected to one or more gNBs or Transmission/Reception Points (TRPS), including the gNB/TRP 121 and the gNB/TRP 122 operating in a licensed band (e.g., 30 GHz-300 GHz for mmWave), of an access network 120 which provides radio access using a Radio Access Technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

Each of the gNB/TRP 121 and the gNB/TRP 122 may provide communication coverage for a geographic coverage area in which communications with the UE 110 is supported via a communication link. The communication links between the gNB/TRP 121/122 and the UE 110 may utilize one or more frequency carriers to form one or more cells (e.g., a PCell and one or more SCells). Specifically, each communication link may be used to carry uplink transmissions from the UE 110 to the associated gNB (e.g., on the Physical Uplink Control Channel (PUCCH) or Physical Uplink Shared Channel (PUSCH)) or to carry downlink transmissions from the associated gNB to the UE 110 (e.g., on the Physical Downlink Control Channel (PDCCH) or Physical Downlink Shared Channel (PDSCH)). For example, the UE 110 may be configured to perform a Discontinuous Reception (DRX) operation in which the UE 110 monitors the PDCCH in the DRX active time (e.g., configured by the gNB/TRP 121/122).

M-DCI based M-TRP transmission for the UE 110 may be RRC configured as follows. If the UE 110 is configured by higher layer parameter “PDCCH-Config” that contains two different values of CORESETPoolIndex in ControlResourceSet, the UE 110 may expect to receive multiple PDCCHs which scheduling fully/partially/non-overlapped PDSCHs in time and frequency domain. The data scheduling from two TRPs (e.g., the gNB/TRP 121 and the gNB/TRP 122) should be scheduled with the same active BWP and the same Sub-Carrier Spacing (SCS). That is, when the UE 110 is scheduled with full/partially/non-overlapped PDSCHs in time and frequency domain, the full scheduling information for receiving a PDSCH is indicated and carried only by the corresponding PDCCH, the UE 110 is expected to be scheduled with the same active BWP and the same SCS. In particular, if the backhaul is non-ideal, it is possible that power saving techniques based on BWP switching (incl. SCell dormancy if M-DCI is supported in SCell) is useless. For example, TRP #1 (e.g., the gNB/TRP 121) is almost impossible to switch BWP even if there is no traffic for the UE 110 because TRP #1 doesn't know the scheduling status of TRP #2 (e.g., the gNB/TRP 122).

In accordance with one novel aspect, the UE 110 may adjust the PDCCH monitoring periodicity in the DRX active time according to an indication of PDCCH monitoring adaptation, which is provided by the 5G NR network 100, to save power consumption. In one embodiment, the PDCCH monitoring adaptation may be DCI-based adaptation, and the indication of PDCCH monitoring adaptation may be included in a bit field of a UE-specific DCI, such as a scheduling DCI using DCI format 0_1, 1_1, 0_2, or 1_2. For example, the UE 110 may be configured with a plurality of SSS's which are configured with different PDCCH monitoring periodicities, and the bit field may be a Search Space Set (SSS) switching field that indicates the UE 110 to switch to an SSS (e.g., dormant SSS) which is configured with no PDCCH monitoring or PDCCH monitoring with longer period or smaller number of PDCCH candidates. Alternatively, the bit field may indicates a ratio of the PDCCH monitoring periodicity reduction, so that the UE 100 may perform PDCCH monitoring with longer period. Alternatively, the bit field may indicates disabling or enabling of the current SSS for the UE 110, and the UE 110 may not perform PDCCH monitoring if the current SSS is disabled. In other words, the UE 110 may adjust (e.g., reduce/decrease or increase) the PDCCH monitoring periodicity based on the bit field of the UE-specific DCI. In one example, the 5G/NR network may configure a timer via UE-specific RRC signaling for the UE to start the timer when receiving the indication of PDCCH monitoring adaptation and adjust the PDCCH monitoring periodicity when the timer expires, to guarantee the data latency. Moreover, in the scenario of M-DCI based M-TRP transmission, the bit field may indicate adaptation on PDCCH monitoring for an SSS having the same Control Resource Set (CORESET) pool index value as the SSS where the UE-specific DCI format is detected.

In another embodiment, the PDCCH monitoring adaptation may be timer-based adaptation, and the indication of PDCCH monitoring adaptation may be received via UE-specific Radio Resource Control (RRC) signaling. For example, the indication of PDCCH monitoring adaptation may include one or more additional timer values that are less than the Bandwidth Part (BWP) inactivity timer value. An additional timer may be started at the start of the DRX active time, and when the additional timer expires, the UE 110 may adjust (e.g., reduce/decrease or increase) the PDCCH monitoring periodicity. Alternatively, the BWP inactivity timer is started at the start of the DRX active time, and when the BWP inactivity timer reaches the additional timer value, the UE 110 may adjust the PDCCH monitoring periodicity. Moreover, in the scenario of M-DCI based M-TRP transmission, the additional timer values are configured for different CORESET pool index values, and the reached timer value and the SSS corresponding to the adjusted PDCCH monitoring periodicity are associated with the same CORESET pool index value.

In another embodiment, the PDCCH monitoring adaptation may be UE autonomous adaptation, and the indication of PDCCH monitoring adaptation may be delivered in data scheduling information. For example, the data scheduling information may be included in a bit field of a UE-specific DCI, such as a scheduling DCI using DCI format 0_1, 1_1, 0_2, or 1_2, and the bit field may indicates data scheduling for the last Transport Block (TB). In response to the data scheduling information, the UE 110 may adjust (e.g., reduce/decrease or increase) the PDCCH monitoring periodicity by switching to an SSS with longer PDCCH monitoring period or scaling down the PDCCH monitoring period by a ratio after transmitting an Acknowledgement (ACK) for the corresponding scheduling data. Moreover, in the scenario of M-DCI based M-TRP transmission, the SSS before the SSS switching and the SSS after the SSS switching may be associated with the same CORESET pool index value.

FIG. 2 illustrates an exemplary DRX operation in accordance with aspects of the current invention. The DRX active time refers to the period of time in which a UE is awake, and the DRX active time may be determined based on parameters (e.g., DRX ON duration timer, DRX inactivity timer, and DRX retransmission timer, etc.) configured by the gNB/TRP 121/122. As shown, the UE wakes up at the beginning of the DRX ON duration of each DRX cycle, and stays awake to monitor the PDCCH and receive downlink data packets, including PDCCH data packets and PDSCH data packets. Intra-packet period is usually caused by scheduling gap for fair scheduling among UEs or by beam sweeping pattern, and is generally in a shorter length when compared to inter-packet period. Inter-packet period is usually due to no data for the UE (i.e., end of data transmission), and is generally in a longer length when compared to intra-packet period.

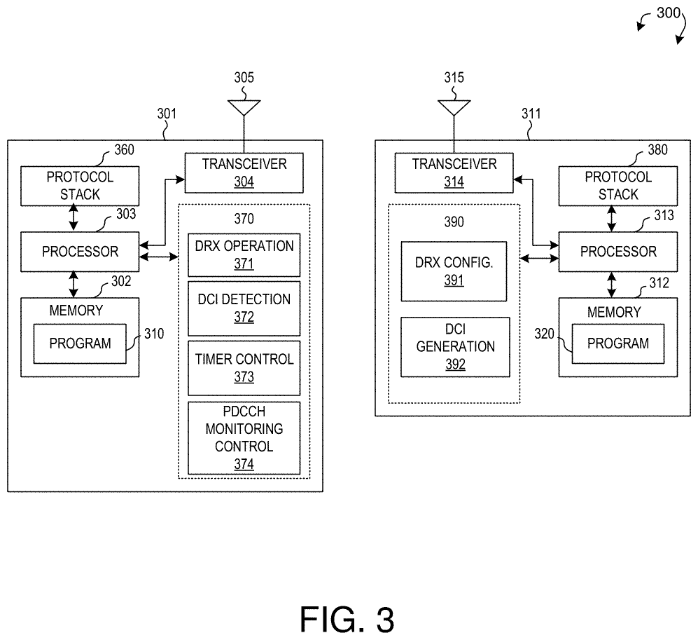

FIG. 3 illustrates simplified block diagrams of wireless devices, e.g., a UE 301 and a gNB/TRP 311 in accordance with embodiments of the current invention. The gNB/TRP 311 has an antenna 315, which transmits and receives radio signals. A Radio Frequency (RF) transceiver module 314, coupled with the antenna 315, receives RF signals from the antenna 315, converts them to baseband signals and sends them to the processor 313. The RF transceiver 314 also converts received baseband signals from the processor 313, converts them to RF signals, and sends out to the antenna 315. The processor 313 processes the received baseband signals and invokes different functional modules to perform features in the gNB/TRP 311. The memory 312 stores program instructions and data 320 to control the operations of the gNB/TRP 311. In the example of FIG. 3, the gNB/TRP 311 also includes a protocol stack 380 and a set of control function modules and circuits 390. The protocol stack 380 may include a Non-Access-Stratum (NAS) layer to communicate with an AMF/SMF/MME entity connecting to the core network, a Radio Resource Control (RRC) layer for high layer configuration and control, a Packet Data Convergence Protocol/Radio Link Control (PDCP/RLC) layer, a Media Access Control (MAC) layer, and a Physical (PHY) layer. In one example, the control function modules and circuits 390 include a DRX configuration circuit 391 that configures the DRX parameters for the UE 301, and a DCI generation circuit 392 that generates DCI with or without an indication of PDCCH monitoring adaptation.

Similarly, the UE 301 has a memory 302, a processor 303, and an RF transceiver module 304. The RF transceiver 304 is coupled with the antenna 305, receives RF signals from the antenna 305, converts them to baseband signals, and sends them to the processor 303. The RF transceiver 304 also converts received baseband signals from the processor 303, converts them to RF signals, and sends out to the antenna 305. The processor 303 processes the received baseband signals and invokes different functional modules and circuits to perform features in the UE 301. The memory 302 stores data and program instructions 310 to be executed by the processor 303 to control the operations of the UE 301. Suitable processors include, by way of example, a special purpose processor, a Digital Signal Processor (DSP), a plurality of micro-processors, one or more micro-processor associated with a DSP core, a controller, a microcontroller, Application Specific Integrated Circuits (ASICs), File Programmable Gate Array (FPGA) circuits, and other type of Integrated Circuits (ICs), and/or state machines. A processor in associated with software may be used to implement and configure features of the UE 301.

The UE 301 also includes a protocol stack 360 and a set of control function modules and circuits 370. The protocol stack 360 may include a NAS layer to communicate with an AMF/SMF/MME entity connecting to the core network, an RRC layer for high layer configuration and control, a PDCP/RLC layer, a MAC layer, and a PHY layer. The Control function modules and circuits 370 may be implemented and configured by software, firmware, hardware, and/or combination thereof. The control function modules and circuits 370, when executed by the processor 303 via program instructions contained in the memory 302, interwork with each other to allow the UE 301 to perform embodiments and functional tasks and features in the network.

In one example, the control function modules and circuits 370 include a DRX operation circuit 371 that performs the DRX operation based on the DRX parameters configured by the gNB/TRP 311, a DCI detection circuit 372 that detects a DCI format with or without an indication of PDCCH monitoring adaptation, a timer control circuit 373 that controls operation of one or more timers, and a PDCCH monitoring control circuit 374 that applies a PDCCH monitoring periodicity configured by the gNB/TRP 311 and adjusts the PDCCH monitoring periodicity in the DRX active time based on the indication of PDCCH monitoring adaptation.

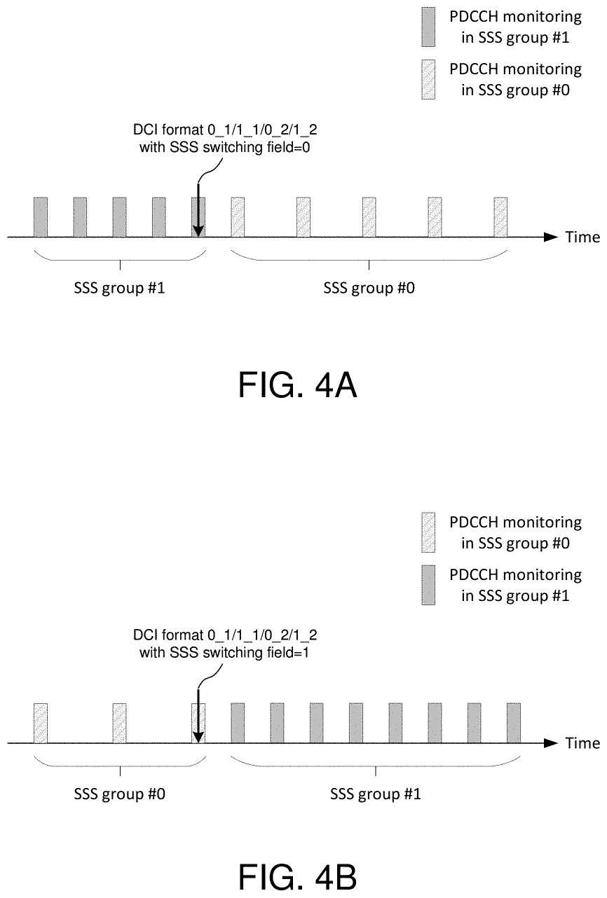

FIGS. 4A and 4B illustrate an embodiment of the DCI-based PDCCH monitoring adaptation in accordance with one novel aspect. A 5G/NR network may configure groups of SSS to a UE, and each SSS group is associated with different PDCCH monitoring periodicity. As shown in FIG. 4A, the UE first performs PDCCH monitoring in an SSS of group #1 which is associated with a shorter PDCCH monitoring period (i.e., smaller PDCCH monitoring periodicity). During the PDCCH monitoring in SSS group #1, the UE receives a DCI format 0_1/1_1/0_2/1_2 comprising an SSS switching field (e.g., with value=0) indicating the UE to switch to SSS group #0. In response to the DCI format 0_1/1_1/0_2/1__2 with an SSS switching field=0, the UE switches to an SSS of group #0 which is associated with a longer PDCCH monitoring period (i.e., greater PDCCH monitoring periodicity). As shown in FIG. 4B, the UE first performs PDCCH monitoring in an SSS of group #0 which is associated with a longer PDCCH monitoring period (i.e., greater PDCCH monitoring periodicity). During the PDCCH monitoring in SSS group #0, the UE receives a DCI format 0_1/1_1/0_2/1_2 comprising an SSS switching field (e.g., with value=1) indicating the UE to switch to SSS group #1. In response to the DCI format 0_1/1_1/0_2/1_2 with an SSS switching field=1, the UE switches to an SSS of group #1 which is associated with a shorter PDCCH monitoring period (i.e., smaller PDCCH monitoring periodicity).

Please note that, although the SSS switching field in the embodiment of FIGS. 4A and 4B is a 1-bit field, the SSS switching field may be an N-bit field in other embodiments, wherein N equals ┌log₂(x)┐ with x being the number of configured groups of SSS.

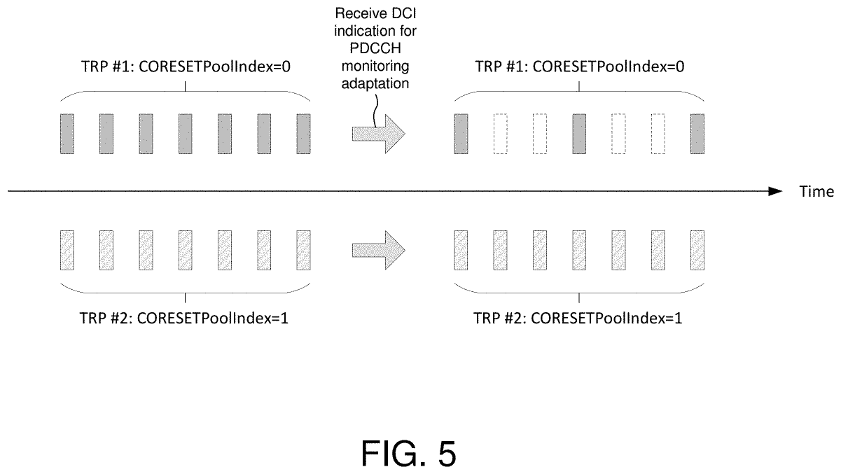

FIG. 5 illustrate an embodiment of the DCI-based PDCCH monitoring adaptation for the scenario of M-DCI based M-TRP transmission in accordance with one novel aspect. As shown in FIG. 5, only the SSS having the same CORESETPoolIndex value as the SSS transmitting the DCI indication is switched.

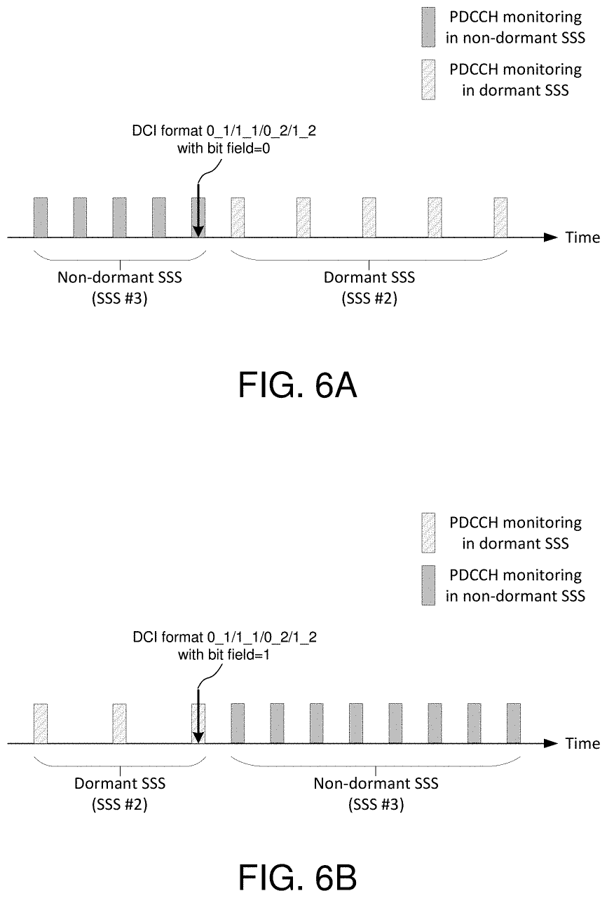

FIGS. 6A and 6B illustrate another embodiment of the DCI-based PDCCH monitoring adaptation in accordance with one novel aspect. A 5G/NR network may configure a plurality of SSS to a UE, and each SSS is associated with different PDCCH monitoring periodicity. Among the configured SSS, at least one SSS may be further configured as the dormant SSS, while the other SSS may be configured as non-dormant SSS. Specifically, the dormant SSS may be associated with no PDCCH monitoring or PDCCH monitoring with longer period or smaller number of PDCCH candidates. As shown in FIG. 6A, the UE first performs PDCCH monitoring in a non-dormant SSS (e.g., SSS #3) which is associated with a shorter PDCCH monitoring period (i.e., smaller PDCCH monitoring periodicity). During the PDCCH monitoring in SSS #3, the UE receives a DCI format 0_1/1_1/0_2/1_2 comprising a bit field (e.g., with value=0) indicating the UE to switch to dormant SSS. In response to the DCI format 0_1/1_1/0_2/1_2 with the bit field=0, the UE switches to the dormant SSS (e.g., SSS #2) which is associated with a longer PDCCH monitoring period (i.e., greater PDCCH monitoring periodicity). As shown in FIG. 6B, the UE first performs PDCCH monitoring in the dormant SSS (e.g., SSS #2) which is associated with a longer PDCCH monitoring period (i.e., greater PDCCH monitoring periodicity). During the PDCCH monitoring in SSS #2, the UE receives a DCI format 0_1/1_1/0_2/1_2 comprising a bit field (e.g., with value=1) indicating the UE to switch to non-dormant SSS. In response to the DCI format 0_1/1_1/0_2/1_2 with the bit field=1, the UE switches to a non-dormant SSS (e.g., SSS #3) which is associated with a shorter PDCCH monitoring period (i.e., smaller PDCCH monitoring periodicity).

Please note that, although not shown in the embodiment of FIGS. 6A and 6B, the bit field in the DCI format 0_1/1_1/0_2/1_2 may be used to indicate the UE to switch all types of SSS to the dormant SSS. In another example, the bit field in the DCI format 0_1/1_1/0_2/1_2 may be used to indicate the UE to switch only type-3 common SSS and UE-specific SSS to the dormant SSS. That is, the UE may continue monitoring non-type-3 common SSS (if configured) after switching to the dormant SSS. In yet another example, the bit field in the DCI format 0_1/1_1/0_2/1_2 may be used to indicate the UE to switch only UE-specific SSS to the dormant SSS. That is, the UE may continue monitoring the common SSS (if configured) after switching to the dormant SSS. Alternatively, the UE may stop monitoring DCI scrambled by any one of a Cell-Radio Network Temporary Identifier (C-RNTI), a Configured Scheduling-RNTI (CS-RNTI), and a Modulation Coding Scheme-Cell-RNTI (MCS-C-RNTI) in response to switching to the dormant SSS.

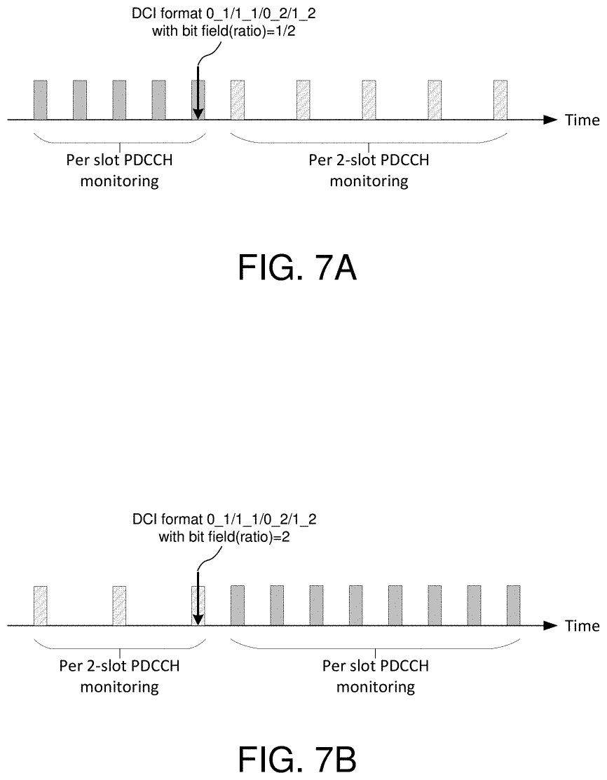

FIGS. 7A and 7B illustrate another embodiment of the DCI-based PDCCH monitoring adaptation in accordance with one novel aspect. As shown in FIG. 7A, the UE first performs PDCCH monitoring per-slot. During the per-slot PDCCH monitoring, the UE receives a DCI format 0_1/1_1/0_2/1_2 comprising a bit field (e.g., with value=1/2) indicating a ratio of PDCCH monitoring periodicity reduction. In response to the DCI format 0_1/1_1/0_2/1_2 with the bit field=1/2, the UE monitors the PDCCH per 2-slot. That is, the UE prolongs the PDCCH monitoring period (i.e., increases the PDCCH monitoring periodicity). As shown in FIG. 7B, the UE first performs PDCCH monitoring per 2-slot. During the per 2-slot PDCCH monitoring, the UE receives a DCI format 0_1/1_1/0_2/1_2 comprising a bit field (e.g., with value=2) indicating a ratio of PDCCH monitoring periodicity reduction. In response to the DCI format 0_1/1_1/0_2/1_2 with the bit field=2, the UE monitors the PDCCH per-slot. That is, the UE shortens the PDCCH monitoring period (i.e., decreases the PDCCH monitoring periodicity).

Please note that, although not shown in the embodiment of FIGS. 7A and 7B, the bit field in the DCI format 0_1/1_1/0_2/1_2 may be used to indicate a ratio of PDCCH monitoring periodicity reduction for all types of SSS. In another example, the bit field in the DCI format 0_1/1_1/0_2/1_2 may be used to indicate a ratio of PDCCH monitoring periodicity reduction for only type-3 common SSS and UE-specific SSS. In yet another example, the bit field in the DCI format 0_1/1_1/0_2/1_2 may be used to indicate a ratio of PDCCH monitoring periodicity reduction for only UE-specific SSS. Alternatively, the 5G/NR network may pre-configure a set of ratios of PDCCH monitoring periodicity reduction to the UE via higher layer signaling or the set of ratios of PDCCH monitoring periodicity reduction may be pre-defined in the 3GPP specifications, and the bit field in the DCI format 0_1/1_1/0_2/1_2 may be used to indicate one of the pre-configured/pre-defined ratios of PDCCH monitoring periodicity reduction.

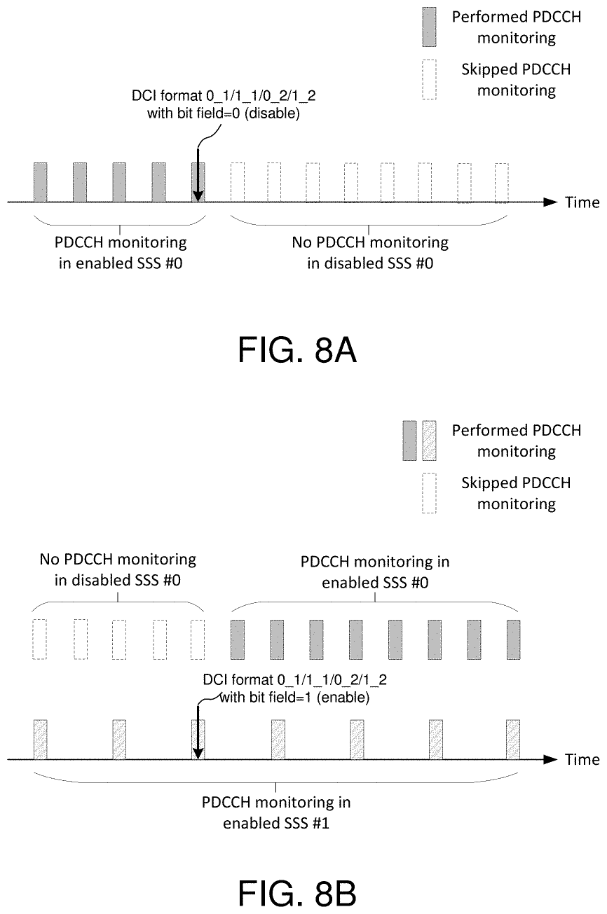

FIGS. 8A and 8B illustrate another embodiment of the DCI-based PDCCH monitoring adaptation in accordance with one novel aspect. As shown in FIG. 8A, the UE first performs PDCCH monitoring in an SSS which is associated with a certain PDCCH monitoring periodicity. During the PDCCH monitoring, the UE receives a DCI format 0_1/1_1/0_2/1_2 comprising a bit field (e.g., with value=0) indicating the UE to disable configured SSS. In response to the DCI format 0_1/1_1/0_2/1_2 with the bit field=0, the UE disables the SSS and stops PDCCH monitoring in the SSS. As shown in FIG. 8B, the UE first performs PDCCH monitoring in SSS #1 which is associated with a certain PDCCH monitoring periodicity, but does not perform PDCCH monitoring in SSS #0 which is disabled. During the PDCCH monitoring in SSS #1, the UE receives a DCI format 0_1/1_1/0_2/1_2 comprising a bit field (e.g., with value=1) indicating the UE to enable configured SSS. In response to the DCI format 0_1/1_1/0_2/1_2 with the bit field=1, the UE enables SSS #0 and performs PDCCH monitoring in SSS #0.

Please note that, although not shown in the embodiment of FIGS. 8A and 8B, the bit field in the DCI format 0_1/1_1/0_2/1_2 may be used to indicate enabling/disabling of all types of SSS. In another example, the bit field in the DCI format 0_1/1_1/0_2/1_2 may be used to indicate enabling/disabling of only type-3 common SSS and UE-specific SSS. In yet another example, the bit field in the DCI format 0_1/1_1/0_2/1_2 may be used to indicate enabling/disabling of only UE-specific SSS. Alternatively, the 5G/NR network may configure a timer via UE-specific RRC signaling for the UE to enable the disabled SSS, so that the UE may start the timer when receiving the DCI indication for disabling an SSS and then enables the disabled SSS when the timer expires.

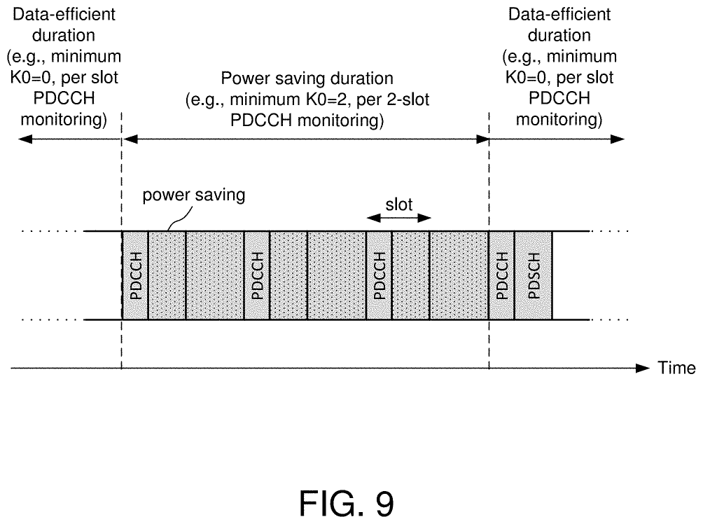

In the embodiments of FIGS. 4A-8B, the bit field in the DCI format 0_1/1_1/0_2/1_2 may be implemented as a newly introduced bit field to indicate the adaptation on PDCCH monitoring. Alternatively, the bit field in the DCI format 0_1/1_1/0_2/1_2 may be implemented as an re-interpreted bit field of “Minimum applicable scheduling offset indicator” for R16 cross-slot scheduling adaptation if the field exists. For example, if only cross-slot scheduling adaptation of R16 feature is configured, the bit field indicates which minimum applicable K0/K2 is used for active DL/UL BWP; if only PDCCH monitoring adaptation of R17 feature is configured, the bit field indicates which adaptation for PDCCH monitoring is used; if both features are configured, the bit field indicates joint adaptation on cross-slot scheduling and PDCCH monitoring, as shown in FIG. 9.

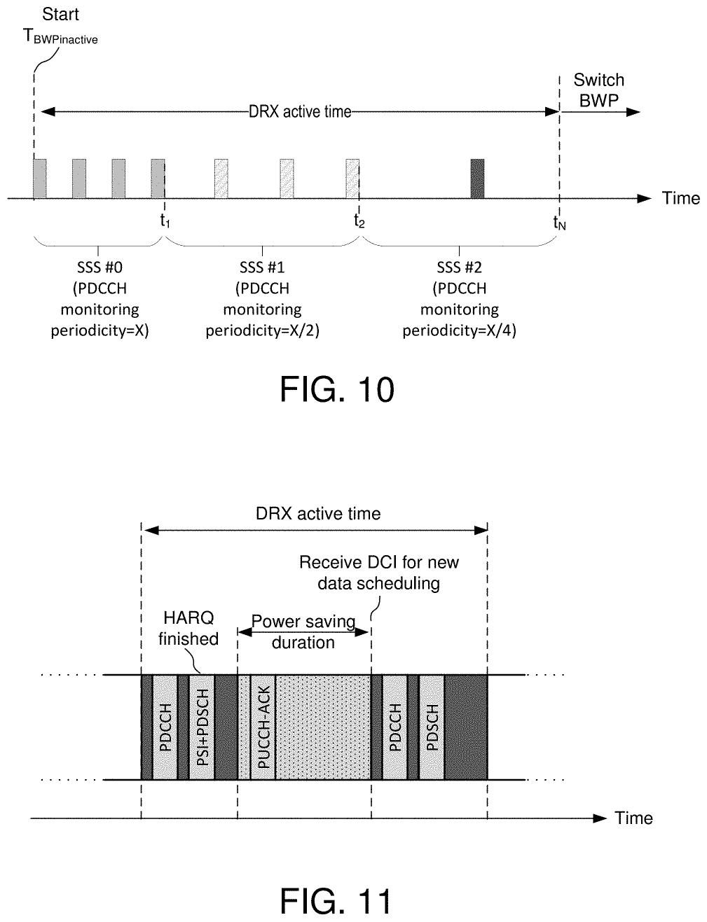

FIG. 10 illustrates an embodiment of the timer-based PDCCH monitoring adaptation in accordance with one novel aspect. When compared to DCI-based adaptation, the benefit of timer-based adaptation is that there is no DCI overhead. In the timer-based adaptation, one or more intermediate timer values/points are introduced for the BWP inactivity timer, and the 5G/NR network may configure these intermediate timer values/points and corresponding SSS via UE-specific RRC signaling. Specifically, the intermediate timer values/points are less than the configured BWP inactivity timer value. As shown in FIG. 10, the BWP inactivity timer value t_{N} and two intermediate timer values t₁ and t₂ are configured, wherein the intermediate timer values correspond to configured SSS #1 and SSS #2, respectively, with different PDCCH monitoring periodicities. At the start of an DRX active time (denoted as t₀), the UE starts the BWP inactivity timer (denoted as T_{BWPinactivity}) and starts to perform PDCCH monitoring in SSS #0 which is associated with a certain PDCCH monitoring periodicity. When the BWP inactivity timer reaches t₁, the UE switches from SSS #0 to SSS #1 with reduced/decreased PDCCH monitoring periodicity. For example, when the UE switches to SSS #1, it can skip intra-burst PDCCH monitoring, and it is beneficial to set a short value for t₁. Later, When the BWP inactivity timer reaches t₂, the UE switches from SSS #1 to SSS #2 with further reduced/decreased PDCCH monitoring periodicity. For example, when the UE switches to SSS #2, it can skip inter-burst PDCCH monitoring, and it is beneficial to set a value no smaller than the Hybrid Automatic Repeat Request (HARQ) feedback time for t₁, to endure good UE data latency. After that, when the BWP inactivity timer expires (i.e., reaches t_{N}), the UE switches from the current BWP to the default BWP.

Please note that, although not shown in the embodiment of FIG. 10, the UE may switch back to the original/initial SSS or the original/initial PDCCH monitoring periodicity when the BWP inactivity timer is reset, e.g., upon receiving scheduling DCI and corresponding data. Alternatively, instead of switching SSS at each intermediate timer point, the UE may just adjust (e.g., reduce/decrease) the PDCCH monitoring periodicity in the current SSS by the corresponding scaled value configured via higher layer signaling when the BWP inactivity timer reaches the intermediate timer point.

FIG. 11 illustrates an embodiment of the UE autonomous PDCCH monitoring adaptation in accordance with one novel aspect. The UE autonomous adaptation is especially beneficial for the UE to reduce/decrease PDCCH monitoring periodicity for inter-burst PDCCH monitoring. When the UE knows the current scheduling is for the last TB, the UE may switch to an SSS with longer PDCCH period or reduce/decrease the PDCCH monitoring periodicity by a ratio after transmitting ACK for the corresponding scheduling data (except that no ACK transmission is needed for PUSCH). As shown in FIG. 11, the UE receives a DCI format 0_1/1_1/0_2/1_2 with a bit field comprising data scheduling information that indicates data scheduling for the last TB. When the UE receives the last TB on the PDSCH and successfully decodes the last TB, the UE enters a power saving duration in which the UE switches to an SSS with longer PDCCH period or reduce/decrease the PDCCH monitoring periodicity. In one example, the 5G/NR network may configure a timer via UE-specific RRC signaling for the UE to start the timer when receiving the DCI indication and enters the power saving duration when the timer expires, to guarantee the data latency. During the power saving duration, the UE receives a DCI indicating new data scheduling. In response to the DCI indicating new data scheduling, the UE leave the power saving duration (by switching back to the original SSS with shorter PDCCH period or increasing the PDCCH monitoring periodicity) to receive new data on the PDSCH.

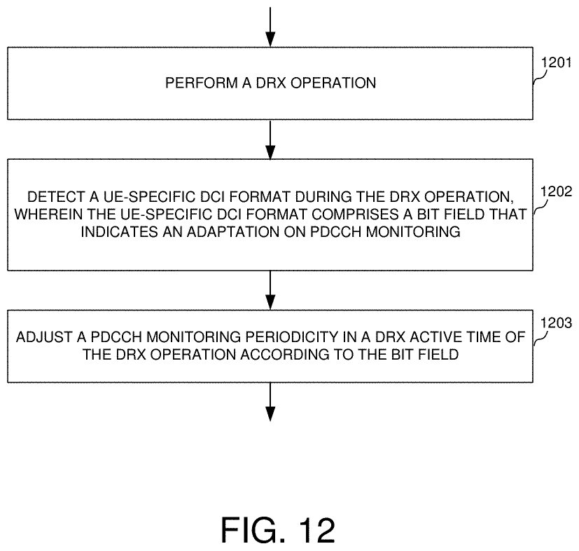

FIG. 12 illustrates a flow chart of a method for DCI-based PDCCH monitoring adaptation in accordance with one novel aspect. In step 1201, a UE performs a DRX operation. In step 1202, the UE detects a UE-specific DCI format during the DRX operation, wherein the UE-specific DCI format comprises a bit field that indicates an adaptation on PDCCH monitoring. In some examples, the UE-specific DCI format is a scheduling DCI using DCI format 0_1, 1_1, 0_2, or 1_2. In step 1203, the UE adjusts a PDCCH monitoring periodicity in a DRX active time of the DRX operation according to the bit field. For example, the adjusting of the PDCCH monitoring periodicity may be performed for all types of SSS, or for type-3 common SSS and UE-specific SSS, or for UE specific SSS only.

In one embodiment, the UE may switch from a first SSS to a second SSS (e.g., a dormant SSS) in response to the bit field indicates SSS switching, wherein the second SSS, compared to the first SSS, is configured with no PDCCH monitoring or PDCCH monitoring with longer period or smaller number of PDCCH candidates. In another embodiment, the bit field may indicate a ratio of PDCCH monitoring periodicity reduction. In yet another embodiment, the UE may disable a configured SSS in response to the bit field indicates SSS disabling, and not perform PDCCH monitoring in response to disabling the configured SSS. In still another embodiment, for the scenario of M-DCI based M-TRP transmission, the bit field may indicate adaptation on PDCCH monitoring for a first SSS having the same CORESET pool index value as a second SSS where the UE-specific DCI format is detected.

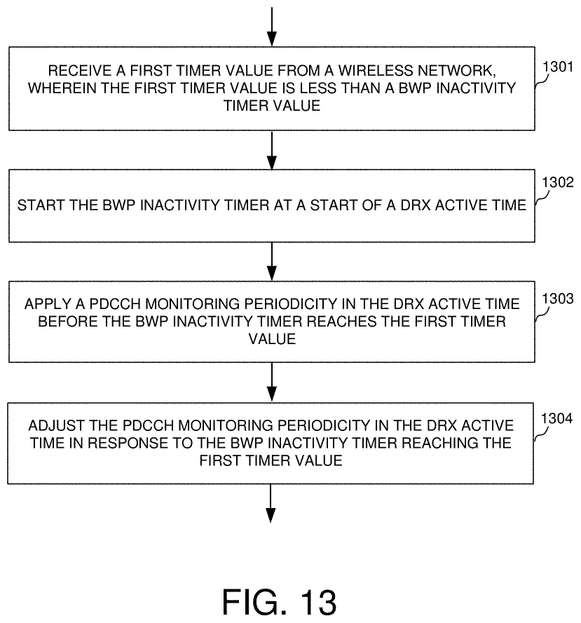

FIG. 13 illustrates a flow chart of a method for timer-based PDCCH monitoring adaptation in accordance with one novel aspect. In step 1301, a UE receives a first timer value from a wireless network, wherein the first timer value is less than a BWP inactivity timer value. For example, the first timer value is received in an RRC message. In step 1302, the UE starts the BWP inactivity timer at a start of a DRX active time. In step 1303, the UE applies a PDCCH monitoring periodicity in the DRX active time before the BWP inactivity timer reaches the first timer value. In step 1304, the UE adjusts the PDCCH monitoring periodicity in the DRX active time in response to the BWP inactivity timer reaching the first timer value.

In one embodiment, the UE may perform PDCCH monitoring in a first SSS using the PDCCH monitoring periodicity from the start of the DRX active time, switches from the first SSS to a second SSS by the UE in response to the BWP inactivity timer reaching the first timer value, and applies the adjusted PDCCH monitoring periodicity in the second SSS by the UE before the BWP inactivity timer expires. In another embodiment, the UE may perform PDCCH monitoring in an SSS using the PDCCH monitoring periodicity before the BWP inactivity timer reaches the first timer value, and applies the adjusted PDCCH monitoring periodicity in the SSS in response to the BWP inactivity timer reaching the first timer value. In yet another embodiment, the UE may apply the adjusted PDCCH monitoring periodicity in response to the BWP inactivity timer reaching the first timer value, and switch back to the PDCCH monitoring periodicity in response to the BWP inactivity timer being reset. In still another embodiment, for the scenario of M-DCI based M-TRP transmission, the first timer value and an SSS corresponding to the adjusted PDCCH monitoring periodicity are associated with the same CORESET pool index value.

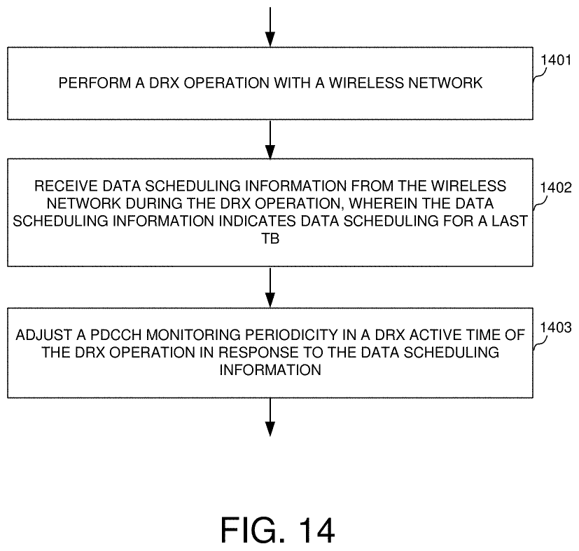

FIG. 14 illustrates a flow chart of a method for UE-autonomous PDCCH monitoring adaptation in accordance with one novel aspect. In step 1401, a UE performs a DRX operation with a wireless network. In step 1402, the UE receives data scheduling information from the wireless network during the DRX operation, wherein the data scheduling information indicates data scheduling for a last TB. For example, the data scheduling information is included in a bit field of a UE-specific DCI format which is a scheduling DCI using DCI format 0_1, 1_1, 0_2, or 1_2. In step 1403, the UE adjusts a PDCCH monitoring periodicity in a DRX active time of the DRX operation in response to the data scheduling information.

In one embodiment, the UE may perform PDCCH monitoring in a first SSS using the PDCCH monitoring periodicity from the start of the DRX active time, switch from the first SSS to a second SSS in response to the bit field, and apply the adjusted PDCCH monitoring periodicity in the second SSS. In particular, for the scenario of M-DCI based M-TRP transmission, the first SSS and the second SSS are associated with the same CORESET pool index value. In another embodiment, the UE may receive an RRC message comprising a timer value, and start the timer in response the UE-specific DCI format, wherein the adjusting of the PDCCH monitoring periodicity is performed when the time expires.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing a Discontinuous Reception (DRX) operation by a User Equipment (UE);
detecting a UE-specific Downlink Control Information (DCI) format during the DRX operation by the UE, wherein the UE-specific DCI format comprises a bit field that indicates an adaptation on Physical Downlink Control Channel (PDCCH) monitoring; and
adjusting a PDCCH monitoring periodicity in a DRX active time of the DRX operation according to the bit field by the UE.

2. The method of claim 1, wherein the UE-specific DCI format is a scheduling DCI using DCI format 0_1, 1_1, 0_2, or 1_2.

3. The method of claim 1, further comprising:
switching from a first Search Space Set (SSS) to a second SSS by the UE in response to the bit field indicates SSS switching;
wherein the second SSS, compared to the first SSS, is configured with no PDCCH monitoring or PDCCH monitoring with longer period or smaller number of PDCCH candidates.

4. The method of claim 3, wherein the second SSS is a dormant SSS.

5. The method of claim 4, further comprising:
stopping monitoring DCI scrambled by any one of a Cell-Radio Network Temporary Identifier (C-RNTI), a Configured Scheduling-RNTI (CS-RNTI), and a Modulation Coding Scheme-Cell-RNTI (MCS-C-RNTI) in response to switching to the dormant SSS.

6. The method of claim 1, wherein the bit field indicates a ratio of PDCCH monitoring periodicity reduction.

7. The method of claim 1, further comprising:
disabling a configured SSS by the UE in response to the bit field indicates SSS disabling; and
stopping performing PDCCH monitoring by the UE in response to disabling the configured SSS.

8. The method of claim 1, wherein the adjusting of the PDCCH monitoring periodicity is performed for all types of SSS, or for type-3 common SSS and UE-specific SSS, or for UE specific SSS only.

9. The method of claim 1, wherein the bit field indicates adaptation on PDCCH monitoring for a first SSS having the same Control Resource Set (CORESET) pool index value as a second SSS where the UE-specific DCI format is detected.

10. The method of claim 1, further comprising:
receiving a Radio Resource Control (RRC) message comprising a timer value by the UE; and
starting the timer by the UE in response the UE-specific DCI format;
wherein the adjusting of the PDCCH monitoring periodicity is performed when the time expires.

11. A UE, comprising:
a DRX operation circuit that performs a DRX operation;
a DCI detection circuit that detects a UE-specific DCI format during the DRX operation, wherein the UE-specific DCI format comprises a bit field that indicates an adaptation on PDCCH monitoring; and
a PDCCH monitoring control circuit that adjusts a PDCCH monitoring periodicity in a DRX active time of the DRX operation according to the bit field.

12. The UE of claim 11, wherein the UE-specific DCI format is a scheduling DCI using DCI format 0_1, 1_1, 0_2, or 1_2.

13. The UE of claim 11, wherein the UE further switches from a first SSS to a second SSS in response to the bit field indicates SSS switching, wherein the second SSS, compared to the first SSS, is configured with no PDCCH monitoring or PDCCH monitoring with longer period or smaller number of PDCCH candidates.

14. The UE of claim 13, wherein the second SSS is a dormant SSS.

15. The UE of claim 14, wherein the UE further stops monitoring DCI scrambled by any one of a C-RNTI, a CS-RNTI, and an MCS-C-RNTI in response to switching to the dormant SSS.

16. The UE of claim 11, wherein the bit field indicates a ratio of PDCCH monitoring periodicity reduction.

17. The UE of claim 11, wherein the UE disables a configured SSS in response to the bit field indicates SSS disabling, and stops performing PDCCH monitoring in response to disabling the configured SSS.

18. The UE of claim 11, wherein the adjusting of the PDCCH monitoring periodicity is performed for all types of SSS, or for type-3 common SSS and UE-specific SSS, or for UE specific SSS only.

19. The UE of claim 11, wherein the bit field indicates adaptation on PDCCH monitoring for a first SSS having the same CORESET pool index value as a second SSS where the UE-specific DCI format is detected.

20. The UE of claim 1, wherein the UE further receives an RRC message comprising a timer value, and starts the timer in response the UE-specific DCI format, wherein the adjusting of the PDCCH monitoring periodicity is performed when the time expires.
